(19) United States
(12) Patent Application Publication
(10) Pub. No.: US 2020/0223242 A1
(43) Pub. Date: Jul. 16, 2020

(54) PRINTING APPARATUS

(71) Applicant: Seiko Epson Corporation, Tokyo (JP)

(72) Inventors: Mayu Arai, Matsumoto-shi (JP); Junya Kato, Matusmoto-shi (JP)

(21) Appl. No.: 15/755,294

(22) PCT Filed: Aug. 23, 2016
(86) PCT No.: PCT/JP2016/003833

§ 371 Date: Feb. 26, 2018

(30) Foreign Application Priority Data
Aug. 26, 2015 (JP) 2015-166481

(51) Int. Cl. B41J 29/38; B65H 23/198; B41J 15/04; B41J 15/16; B65H 23/185

(52) U.S. Cl. CPC B41J 29/38; B65H 23/198; B41J 15/04; B65H 2404/6111; B65H 23/185; B65H 2301/41346; B41J 15/165

(57) ABSTRACT

There is provided a printing apparatus that is capable of reducing an occurrence of transport disorder of a medium when transporting the medium unwound from an unwinding unit that holds a roll body.

The printing apparatus performs printing on the medium unwound from the roll body having the medium wound into a cylindrical shape, the printing apparatus including: an unwinding unit 40 that rotatably holds the roll body and unwinds the medium by rotating the roll body; a transport unit that transports the medium unwound from the unwinding unit 40; and a printing unit that performs printing on the medium transported by the transport unit. The unwinding unit 40 includes a first rotary body 441 that is integrally rotatable with the roll body by engaging with a first end of the roll body, a second rotary body 451 that is integrally rotatable with the roll body by engaging with a second end of the roll body, a first motor 442 that rotatably drives the first rotary body 441, and a second motor 452 that rotatably drives the second rotary body 451.

### TECHNICAL FIELD

The present invention relates to a printing apparatus such as an ink jet printer.

### BACKGROUND ART

In the related art, there has been known an ink jet type printing apparatus that discharges ink to a medium such as paper and performs printing on the medium. Among such printing apparatuses, an apparatus includes an unwinding unit that rotatably holds a roll body having a medium wound into a cylindrical shape and rotates the roll body held by the unwinding unit so as to perform printing on the unwound medium (for example, PTL 1).

### CITATION LIST

### Patent Literature

PTL 1: Japanese Unexamined Patent Application Publication No. 2013-223977

### SUMMARY OF INVENTION

### Technical Problem

However, in the printing apparatus described above, when the medium is unwound from the unwinding unit, torque for rotating the roll body is applied to one end of the roll body in its axial direction. Therefore, when the roll body increases in length in the axial direction, there is a concern that torsion will be generated in the roll body around the axial direction, and thus an unwinding amount of the medium from the unwinding unit is not uniform in the axial direction. As a result, when the unwound medium is transported, there is a concern that transport disorder of the medium will occur.

The present invention is made in consideration of the circumstances described above. An object of the invention is to provide a printing apparatus that is capable of reducing an occurrence of transport disorder of a medium when transporting the medium unwound from an unwinding unit that holds a roll body.

### Solution to Problem

Hereinafter, means for solving the problem described above and operation effects thereof will be described.

In order to solve the problem described above, there is provide a printing apparatus that performs printing on a medium unwound from a roll body having the medium wound into a cylindrical shape, the printing apparatus including: an unwinding unit that rotatably holds the roll body and unwinds the medium by rotating the roll body; a transport unit that transports the medium unwound from the unwinding unit; and a printing unit that performs printing on the medium transported by the transport unit. The unwinding unit includes a first rotary body that is integrally rotatable with the roll body by engaging with a first end of the roll body, a first drive unit that rotatably drives the first rotary body, a second rotary body that is integrally rotatable with the roll body by engaging with a second end of the roll body, and a second drive unit that rotatably drives the second rotary body.

In this configuration, both ends of the roll body engage with the first rotary body and the second rotary body of the unwinding unit, and thereby the unwinding unit is capable of holding the roll body. The first drive unit and the second drive unit of the unwinding unit rotatably drive the first rotary body and the second rotary body, and thereby it is possible to apply torque for rotating the roll body to both ends of the roll body. Hence, as the torque is applied from both ends, torsion is unlikely to be generated in the roll body around its axial direction, and thus an unwinding amount of the medium from the unwinding unit is likely to be uniform in a width direction. Hence, when transporting the medium unwound from an unwinding unit that holds a roll body, it is possible to reduce an occurrence of transport disorder such as an occurrence of wrinkles or skewing of the medium.

It is preferable that the printing apparatus further include a winding unit that rotatably holds the roll body and rotates the roll body so as to wind the medium on which printing has been performed by the printing portion, and the winding unit include a first rotary body that is integrally rotatable with the roll body by engaging with the first end of the roll body, a first drive unit that rotatably drives the first rotary body, a second rotary body that is integrally rotatable with the roll body by engaging with the second end of the roll body, and a second drive unit that rotatably drives the second rotary body.

In the winding unit, when the torsion is generated in the roll body around the axial direction, winding disorder in which the medium is wound while shifting in the width direction or the like is likely to occur. In this configuration, since it is possible to apply the torque for rotating the roll body to both ends of the roll body, the torsion is unlikely to be generated in the roll body around the axial direction. Hence, it is possible to reduce the occurrence of winding disorder of the medium.

In the printing apparatus, it is preferable that, when a direction in which the first rotary body and the second rotary body of the unwinding unit face each other is a width direction, the unwinding unit include an intermediate holder provided with a first intermediate rotary body that is integrally rotatable with the roll body by engaging with the second end of the roll body of which the first end engages with the first rotary body of the unwinding unit and a second intermediate rotary body that is integrally rotatable with the roll body by engaging with the first end of the roll body of which the second end engages with the second rotary body of the unwinding unit, the intermediate holder being installed between the first rotary body and the second rotary body of the unwinding unit in the width direction.

In this configuration, the intermediate holder is installed in the unwinding unit. In this manner, both ends of one roll body (hereinafter, referred to as a “first roll body”) engage with the first rotary body and the first intermediate rotary body of the unwinding unit, and both ends of the other roll body (hereinafter, referred to as a “second roll body”) engage with the second rotary body and the second intermediate rotary body of the unwinding unit. Thus, the unwinding unit is capable of holding the two roll bodies. The first drive unit of the unwinding unit rotatably drives the first rotary body, and thereby one medium (hereinafter, referred to as a “first medium”) is unwound from the first roll body. In addition, the second drive unit of the unwinding unit rotatably drives the second rotary body, and thereby the other medium (hereinafter, referred to as a “second medium”) can be unwound from the second roll body.

Here, since the intermediate holder having the first intermediate rotary body and the second intermediate rotary body is installed between the first rotary body and the second rotary body of the unwinding unit, the lengths of the first roll body and the second roll body are likely to be shorter than the length of one roll body in the width direction when the unwinding unit holds the one corresponding roll body via the first rotary body and the second rotary body. In other words, even in a case of rotating the roll body by applying the torque to one end in the width direction, the torsion is unlikely to be generated in the first roll body and the second roll body around the axial direction.

Hence, in this configuration, while reducing the occurrence of transport disorder, it is possible to perform printing on the two media at the same time, and thus it is possible to increase printing efficiency.

In the printing apparatus, it is preferable that the winding unit include an intermediate holder provided with a first intermediate rotary body that is integrally rotatable with the roll body by engaging with the second end of the roll body of which the first end engages with the first rotary body of the winding unit and a second intermediate rotary body that is integrally rotatable with the roll body by engaging with the first end of the roll body of which the second end engages with the second rotary body of the winding unit, the intermediate holder being installed between the first rotary body and the second rotary body of the winding unit.

In this configuration, the intermediate holders are installed in the unwinding unit and the winding unit. In this manner, in a case where printing is performed on the two media unwound from the two roll bodies, it is possible to individually wind the two media into roll bodies. In addition, in a case where transport rates of the first medium and the second medium are equal to each other, it is possible to cope with a case where rotation speeds of the first roll body and the second roll body need to be different from each other in the unwinding unit such as a case where outer diameters of the first roll body and the second roll body of the unwinding unit are different from each other.

In the printing apparatus, it is preferable that, when the medium unwound from the roll body of which both ends engage with the first rotary body and the first intermediate rotary body of the unwinding unit is a first medium, and the medium unwound from the roll body of which both ends engage with the second rotary body and the second intermediate rotary body of the unwinding unit is a second medium, of the first medium and the second medium, one medium be allowed to be transported, but the other medium be restricted from being transported in a case where printing is not performed on the other medium in the middle of performing printing on the one medium.

In this configuration, in a case where, of the first medium and the second medium, the other medium is restricted from being continuously transported in a case where printing is not performed on the other medium in the middle of performing printing on the one medium (for example, a case where printing is finished first). Hence, the medium, on which printing is not performed, is continuously transported, and thereby it is possible to avoid wasteful consumption of the corresponding medium.

It is preferable that the printing apparatus further include a first tension applying portion that is capable of applying tension to the first medium by pressing the first medium in a direction intersecting with both directions of a transport direction of the first medium and the width direction and a second tension applying portion that is capable of applying tension to the second medium by pressing the second medium in a direction intersecting with both directions of a transport direction of the second medium and the width direction, when the medium unwound from the roll body of which both ends engage with the first rotary body and the first intermediate rotary body of the unwinding unit is a first medium, and the medium unwound from the roll body of which both ends engage with the second rotary body and the second intermediate rotary body of the unwinding unit is a second medium.

In this configuration, by the first tension applying portion and the second tension applying portion, it is possible to individually apply different tension to the first medium and the second medium. Therefore, it is possible to change the tension, which is applied to the first medium and the second medium, depending on a type of medium, or depending on an outer diameter of the roll body in the winding unit.

In the printing apparatus, it is preferable that the first tension applying portion and the second tension applying portion can be connected to each other in the width direction.

In this configuration, in a case where the unwinding unit holds one roll body via the first rotary body and the second rotary body, the first tension applying portion and the second tension applying portion connected to each other in the width direction press the medium unwound from one corresponding roll body, and thereby uniform tension can be applied to one medium in the width direction. Therefore, compared to a case where the first tension applying portion and the second tension applying portion individually apply tension to one medium, the winding disorder is unlikely to occur.

### BRIEF DESCRIPTION OF DRAWINGS

FIG. 1 is a perspective view of a printing apparatus according to an embodiment.

FIG. 2 is a sectional side view of the printing apparatus.

FIG. 3 is a partial front view of the printing apparatus.

FIG. 4 is a partial front view of the printing apparatus in a case where printing is performed on a medium unwound from one roll body.

FIG. 5 is a partial front view of the printing apparatus in a case where printing is performed on media unwound from two roll bodies.

### DESCRIPTION OF EMBODIMENTS

Hereinafter, an embodiment of a printing apparatus will be described with reference to the figures. The printing apparatus of the embodiment is a large format printer that performs printing on long paper unwound from a roll body.

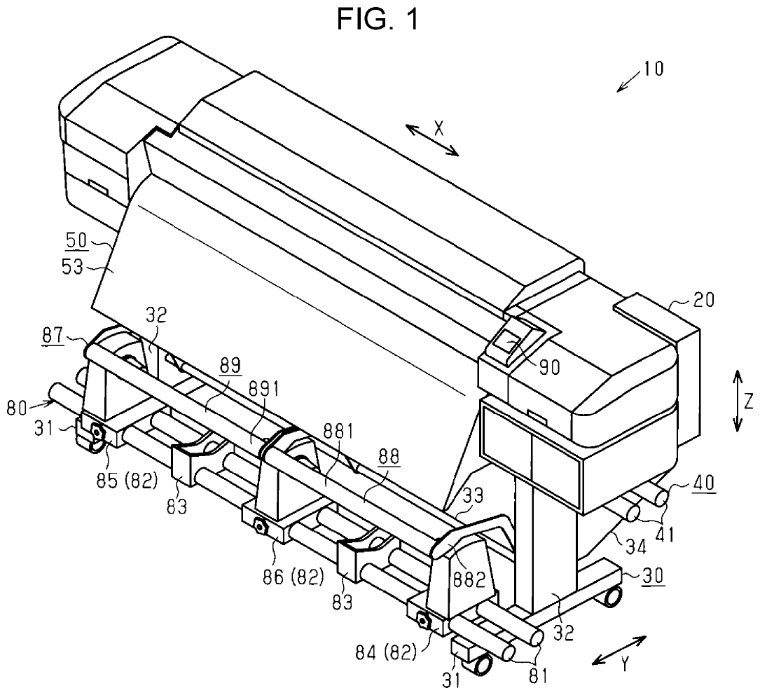

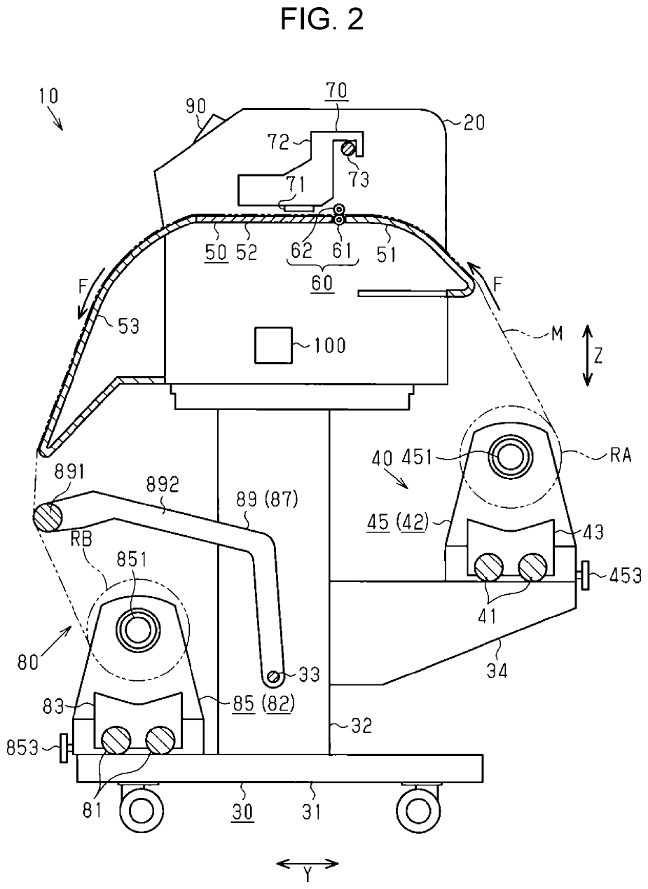

As illustrated in FIG. 1, a printing apparatus 10 includes a housing 20 having a box shape and a housing support 30 that supports the housing 20. In addition, as illustrated in FIG. 2, the printing apparatus 10 includes an unwinding unit 40 that unwinds a medium M wound into a roll body RA along a transport direction of the medium M, a medium support 50 that supports the medium M, a transport unit 60 that transports the medium M, a printing unit 70 that performs printing on the medium M, and a winding unit 80 that winds the medium M into a roll body RB. Further, as illustrated in FIGS. 1 and 2, the printing apparatus 10 includes an operating unit 90 that is operated by a user and a controller 100 that collectively controls the apparatus.

In the following description, a width direction of the printing apparatus 10 is referred to as a “width direction X”, a front/rear direction of the printing apparatus 10 is referred to as a “front/rear direction Y”, a vertical direction of the printing apparatus 10 is referred to as a “vertical direction Z”, and a transport direction of the medium M is referred to as a “transport direction F”. Here, the width direction X, the front/rear direction Y, and the vertical direction Z are directions intersecting with (orthogonal to) each other, and the width direction X is a direction intersecting with (orthogonal to) the transport direction F. In addition, one end (lower right end in FIG. 1) in the width direction X is referred to as a “first end”, and the other end (upper left end in FIG. 1) in the width direction X is referred to as a “second end”.

As illustrated in FIGS. 1 and 2, the housing support 30 includes a first leg 31 having a longitudinal direction in the front/rear direction Y, a second leg 32 extending upward from the first leg 31, a connecting shaft 33 that connects the second legs 32 in the width direction X, and an extension portion 34 extending rearward from the second leg 32. The first legs 31 and the second legs 32 are provided to form pairs in the width direction X. In addition, an upper end portion of the second leg 32 on a side opposite to a lower end portion connected to the first leg 31 is connected to the housing 20.

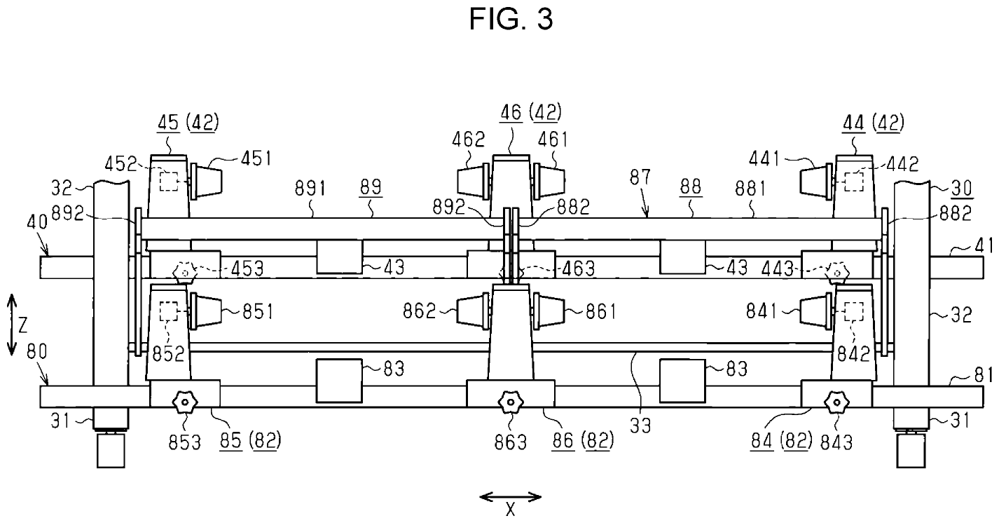

As illustrated in FIGS. 1 and 2, the unwinding unit 40 is supported on the extension portion 34 of the housing support 30 on a lower rear side of the housing 20. As illustrated in FIGS. 2 and 3, the unwinding unit 40 includes a guide shaft 41 that is provided over the extension portion 34, with a longitudinal direction of the shaft in the width direction X, a holder 42 that rotatably holds the roll body RA having the medium M wound into a cylindrical shape, and a mounting portion 43 on which the roll body RA is temporarily mounted during attachment and detachment of the roll body RA. The guide shafts 41 are provided to form a pair in the front/rear direction Y, and the mounting portions 43 are provided to form a pair in the width direction X.

As illustrated in FIG. 3, the holder 42 has a first holder 44 that is provided at the first end in the width direction X, a second holder 45 that is provided at the second end in the width direction X, and an intermediate holder 46 that is detachably provided between the first holder 44 and the second holder 45 in the width direction X. The first holder 44, the second holder 45, and the intermediate holder 46 are supported to be slidable with respect to the guide shaft 41.

The first holder 44 is provided with a first rotary body 441 that is integrally rotatable with the roll body RA by engaging with the first end of the roll body RA, a first motor 442 that rotatably drives the first rotary body 441, and a fixing screw 443 that allows or restricts movement of the first holder 44 with respect to the guide shaft 41 in the width direction X. In addition, the second holder 45 is provided with a second rotary body 451 that is integrally rotatable with the roll body RA by engaging with the second end of the roll body RA, a second motor 452 that rotatably drives the second rotary body 451, and a fixing screw 453 that allows or restricts movement of the second holder 45 with respect to the guide shaft 41 in the width direction X.

In this respect, in the embodiment, the first motor 442 corresponds to an example of a “first drive unit that rotatably drives the first rotary body of the unwinding unit”, and the second motor 452 corresponds to an example of a “second drive unit that rotatably drives the second rotary body of the unwinding unit”. In addition, the first motor 442 and the second motor 452 may drive the first rotary body 441 and the second rotary body 451 via a deceleration device.

The intermediate holder 46 is provided with a first intermediate rotary body 461 that is integrally rotatable with the roll body RA by engaging with the second end of the roll body RA, of which the first end engages with the first rotary body 441, and a second intermediate rotary body 462 that is integrally rotatable with the roll body RA by engaging with the first end of the roll body RA, of which the second end engages with the second rotary body 451. In addition, the intermediate holder 46 includes a fixing screw 463 that allows or restricts movement of the intermediate holder 46 with respect to the guide shaft 41 in the width direction X.

The first intermediate rotary body 461 and the second intermediate rotary body 462 of the intermediate holder 46 are different from the first rotary body 441 and the second rotary body 451 of the first holder 44 and the second holder 45 and are only driven following rotation of the first and second rotary bodies without being directly driven. In addition, the first intermediate rotary body 461 and the second intermediate rotary body 462 can rotate at different rotation speeds from each other.

The first rotary body 441 of the first holder 44, the second rotary body 451 of the second holder 45, and the first intermediate rotary body 461 and the second intermediate rotary body 462 of the intermediate holder 46 integrally rotate with the roll body RA by fitting into (engaging with) an end portion of a core member (for example, a paper pipe) of the roll body RA in a state of being inserted into the end portion thereof. Therefore, the first rotary body 441 of the first holder 44, the second rotary body 451 of the second holder 45, and the first intermediate rotary body 461 and the second intermediate rotary body 462 of the intermediate holder 46 have a substantially truncated cone shape such that the bodies taper from a base end to a front end.

In addition, in the embodiment, the intermediate holder 46 is attachable to and detachable from the unwinding unit 40. Therefore, in a case where the intermediate holder 46 is not provided in the unwinding unit 40, the first rotary body 441 of the first holder 44 and the second rotary body 451 of the second holder 45 engage with both ends of the roll body RA. In this case, the unwinding unit 40 unwinds one medium M wound into one roll body RA by rotating the roll body RA.

On the other hand, in a case where the unwinding unit 40 includes the intermediate holder 46, the first rotary body 441 of the first holder 44 and the first intermediate rotary body 461 of the intermediate holder 46 engage with both ends of one roll body, and the second rotary body 451 of the second holder 45 and the second intermediate rotary body 462 of the intermediate holder 46 engage with both ends of the other roll body. In this case, the unwinding unit 40 unwinds two media M wound into one roll body and the other roll body by rotating the one roll body and the other roll body.

In the following description, the one roll body is referred to as a “first roll body RA1”, and the other roll body is referred to as a “second roll body RA2”. In addition, a medium M unwound from the first roll body RA1 is referred to as a “first medium M1”, and a medium M unwound from the second roll body RA2 is referred to as a “second medium M2”.

As illustrated in FIG. 2, the medium support 50 is provided with a first medium support 51 that is formed from a lower rear side of the housing 20 to the housing 20, a second medium support 52 that is formed toward the front side in the inside of the housing 20, and a third medium support 53 that is formed from the housing 20 to a lower front side of the housing 20. The medium support 50 guides the medium M unwound from the unwinding unit 40 to the winding unit 80 and supports the medium M. In a case where the medium M needs to be heated before and after printing depending on a printing method of the printing apparatus 10, a heater for heating the medium M may be installed inside the medium support 50.

As illustrated in FIG. 2, the transport unit 60 includes a drive roller 61 that rotates while coming into contact with a back surface of the medium M and a driven roller 62 that rotates while coming into contact with a front surface of the medium M. The transport unit 60 drives the drive roller 61 in a state in which the medium M is pinched between the drive roller 61 and the driven roller 62. In this manner, the medium M unwound from the unwinding unit 40 is transported in the transport direction F. In the following description, a “transport operation” means that the transport unit 60 transports the medium M by a predetermined amount in the transport direction F. In addition, when the transport operation is performed, unwinding of the medium M by the unwinding unit 40 and winding of the medium M by the winding unit 80 are performed at the same time.

As illustrated in FIG. 2, the printing unit 70 includes a discharge portion 71 that discharges ink, a carriage 72 that holds the discharge portion 71, and a guide shaft 73 that supports the carriage 72, with a longitudinal direction of the shaft in the width direction X. While the carriage 72 is caused to move in the width direction X which is the longitudinal direction of the guide shaft 73, the printing unit 70 performs printing for one pass by performing a “discharge operation” of discharging ink from the discharge portion 71 to the medium M.

As illustrated in FIGS. 1 and 2, the winding unit 80 is supported in front the first leg 31 of the housing support 30. As illustrated in FIGS. 2 and 3, the winding unit 80 includes a guide shaft 81 that is provided over the first legs 31, with a longitudinal direction of the shaft in the width direction X, a holder 82 that rotatably holds the roll body RB having the medium M wound into a cylindrical shape, and a mounting portion 83 on which the roll body RB is temporarily mounted during attachment and detachment of the roll body RB. The guide shafts 81 are provided to form a pair in the front/rear direction Y, and the mounting portions 83 are provided to form a pair in the width direction X.

The holder 82 has a first holder 84 that is provided at the first end in the width direction X, a second holder 85 that is provided at the second end in the width direction X, and an intermediate holder 86 that is detachably provided between the first holder 84 and the second holder 85 in the width direction X. The first holder 84, the second holder 85, and the intermediate holder 86 are supported to be slidable with respect to the guide shaft 81.

The first holder 84 is provided with a first rotary body 841 that is integrally rotatable with the roll body RB by engaging with the first end of the roll body RB, a first motor 842 that rotatably drives the first rotary body 841, and a fixing screw 843 that allows or restricts movement of the first holder 84 with respect to the guide shaft 81 in the width direction X. In addition, the second holder 85 is provided with a second rotary body 851 that is integrally rotatable with the roll body RB by engaging with the second end of the roll body RB, a second motor 852 that rotatably drives the second rotary body 851, and a fixing screw 853 that allows or restricts movement of the second holder 85 with respect to the guide shaft 81 in the width direction X.

In this respect, in the embodiment, the first motor 842 corresponds to an example of a “first drive unit that rotatably drives the first rotary body of the winding unit”, and the second motor 852 corresponds to an example of a “second drive unit that rotatably drives the second rotary body of the winding unit”. In addition, the first motor 842 and the second motor 852 may drive the first rotary body 841 and the second rotary body 851 via a deceleration device.

The intermediate holder 86 is provided with a first intermediate rotary body 861 that is integrally rotatable with the roll body RB by engaging with the second end of the roll body RB, of which the first end engages with the first rotary body 841, and a second intermediate rotary body 862 that is integrally rotatable with the roll body RB by engaging with the first end of the roll body RB, of which the second end engages with the second rotary body 851. In addition, the intermediate holder 86 includes a fixing screw 863 that allows or restricts movement of the intermediate holder 86 with respect to the guide shaft 81 in the width direction X.

The first intermediate rotary body 861 and the second intermediate rotary body 862 of the intermediate holder 86 are different from the first rotary body 841 and the second rotary body 851 of the first holder 84 and the second holder 85 and are only driven following rotation of the first and second rotary bodies without being directly driven. In addition, the first intermediate rotary body 861 and the second intermediate rotary body 862 can rotate at different rotation speeds from each other.

The first rotary body 841 of the first holder 84, the second rotary body 851 of the second holder 85, and the first intermediate rotary body 861 and the second intermediate rotary body 862 of the intermediate holder 86 integrally rotate with the roll body RB by fitting into (engaging with) an end portion of a core member (for example, a paper pipe) of the roll body RB in a state of being inserted into the end portion thereof. Therefore, the first rotary body 841 of the first holder 84, the second rotary body 851 of the second holder 85, and the first intermediate rotary body 861 and the second intermediate rotary body 862 of the intermediate holder 86 have a substantially truncated cone shape such that the bodies taper from a base end to a front end.

In addition, in the embodiment, the intermediate holder 86 is attachable to and detachable from the winding unit 80. Therefore, in a case where the intermediate holder 86 is not provided in the winding unit 80, the first rotary body 841 of the first holder 84 and the second rotary body 851 of the second holder 85 engage with both ends of the roll body RB. In this case, the winding unit 80 winds one medium M wound into one roll body RB by rotating the roll body RB.

On the other hand, in a case where the winding unit 80 includes the intermediate holder 86, the first rotary body 841 of the first holder 84 and the first intermediate rotary body 861 of the intermediate holder 86 engage with both ends of one roll body, and the second rotary body 851 of the second holder 85 and the second intermediate rotary body 862 of the intermediate holder 86 engage with both ends of the other roll body. In this case, the winding unit 80 winds two media M wound into one roll body and the other roll body by rotating the one roll body and the other roll body.

In the following description, the one roll body is referred to as a “first roll body RB1”, and the other roll body is referred to as a “second roll body RB2”. In other words, the first medium M1 is wound into the first roll body RB1, and the second medium M2 is wound into the second roll body RB2.

In addition, as illustrated in FIG. 1, the winding unit 80 includes a tension applying mechanism 87 that applies tension to the medium M when the medium M is wound into the roll body RB. The tension applying mechanism 87 is provided with a first tension applying portion 88 that is provided at the first end in the width direction X and a second tension applying portion 89 that is provided at the second end in the width direction X. In other words, the first tension applying portion 88 and the second tension applying portion 89 are provided to be adjacent to each other in the width direction X.

As illustrated in FIG. 3, the first tension applying portion 88 has a first pressing portion 881 having a circular cylinder shape with its axial direction in the width direction X and first arm members 882 that form a pair and support the first pressing portion 881 at its front end. In addition, the second tension applying portion 89 has a second pressing portion 891 having a circular cylinder shape with its axial direction in the width direction X and second arm members 892 that form a pair and support the second pressing portion 891 at its front end.

In the embodiment, the first pressing portion 881 and the second pressing portion 891 are equal in length in the width direction X. In other words, the length of each of the first pressing portion 881 and the second pressing portion 891 in the width direction X is about half of a length of a distance between the second legs 32 in the width direction. In addition, as illustrated in FIGS. 2 and 3, the first arm member 882 and the second arm member 892 have base end portions into which connecting shafts 33 that connect the second legs 32 of the housing support 30 in the width direction X are inserted.

The first tension applying portion 88 and the second tension applying portion 89 can individually oscillate with the connecting shaft 33 as an oscillation center. In addition, the first tension applying portion 88 and the second tension applying portion 89 connect the first arm member 882 and the second arm member 892 on the central side in the width direction X. In this manner, the first tension applying portion 88 and the second tension applying portion 89 can integrally oscillate with the connecting shaft 33 as the oscillation center.

In addition, since the first tension applying portion 88 and the second tension applying portion 89 have the center of gravity positioned on a side from the oscillation center when applying tension to the medium M, the first tension applying portion 88 and the second tension applying portion 89 fall down to a lower front side due to their own weight with the connecting shaft 33 as the oscillation center. In this manner, the first tension applying portion 88 and the second tension applying portion 89 press the medium M in a direction intersecting with the width direction X and the transport direction F and apply the tension to the medium M in the transport direction F. In a case where the first roll body RB1 and the second roll body RB2 are held in the winding unit 80, the first tension applying portion 88 applies the tension to the medium M1 that is wound into the first roll body RB1, and the second tension applying portion 89 applies the tension to the medium M2 that is wound into the second roll body RB2.

In addition, since the tension applying mechanism 87 is capable of applying the tension to the medium M, it is possible to transport the medium M without loosening of the medium even when the unwinding of the medium M by the unwinding unit 40 and the winding of the medium M by the winding unit 80 are not performed in synchronization with each other during the transport operation.

As illustrated in FIGS. 1 and 2, the operating unit 90 is provided on an upper surface of the printing apparatus 10. The operating unit 90 is operated by a user in a case where various types of settings of the printing apparatus 10 are performed or in a case where execution of the printing by the printing apparatus 10 is assisted. Therefore, preferably, the operating unit 90 includes a plurality of buttons or a liquid crystal display.

The controller 100 is a so-called microcomputer that includes a CPU, a ROM, and a RAM. For example, the controller 100 controls drive of configurations based on a print jet input to the printing apparatus 10, and thereby the transport operation and the discharge operation are alternately performed, and printing is performed on the medium M.

Additionally, in the embodiment, in the transport operation performed in a case where printing is performed on the two media M1 and M2 at the same time, the transport unit 60 transports the two media M1 and M2 in the same manner. Therefore, transport amounts of the two media M1 and M2 are equal to each other. In addition, in the transport operation performed in a case where printing is performed on the two media M1 and M2 at the same time, ink is discharged to the two media M1 and M2 from the discharge portion 71 held by the carriage 72 that moves to pass across the two media M1 and M2 in the width direction X.

Further, in the embodiment, when the transport of the medium M continues, and the outer diameter of the roll body RA held in the unwinding unit 40 is small, an unwinding amount of the medium M when the roll body RA is rotated by 360 degrees is small. On the other hand, when the transport of the medium M continues, and the outer diameter of the roll body RB held in the winding unit 80 is large, a winding amount of the medium M when the roll body RB is rotated by 360 degrees is large. Hence, as the transport of the medium M continues, the controller 100 increases the number of rotations of the first motor 442 and the second motor 452 of the unwinding unit 40 and decreases the number of rotations of the first motor 842 and the second motor 852 of the winding unit 80.

In addition, in the printing apparatus 10 of the embodiment, in a case where the printing is performed on the two media M1, and M2 at the same time, of the two roll bodies RA1 and RA2, in the middle of performing printing on one medium M unwound from one roll body, printing is finished on the other medium M unwound from the other roll body. In other words, in the middle of performing the printing on the one medium M unwound from the one roll body, printing is not performed on the other medium M unwound from the other roll body. In this case, at the time when the printing is finished on the other medium M, the controller 100 restricts the other medium M from being transported while allowing the one medium M to be transported.

Specifically, at the time when the printing is finished on the other medium M (for example, the first medium M1), the controller 100 stops the motor (for example, the first motor 442) that rotatably drives the rotary body engaging with the end of the roll body RA into which the other medium M is wound. In addition, Specifically, the controller 100 stops the motor (for example, the first motor 842) that rotatably drives the rotary body engaging with the end of the roll body RB into which the other medium M is wound.

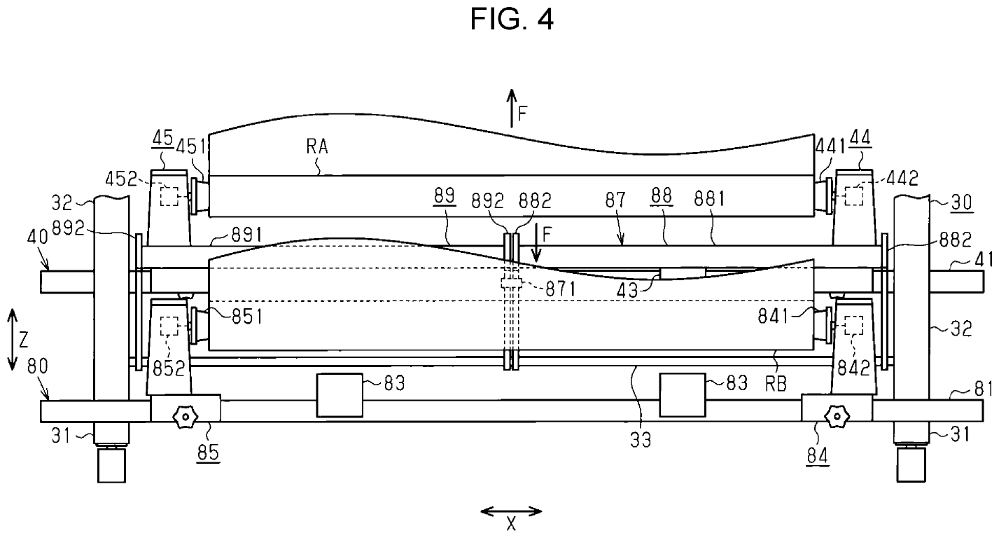

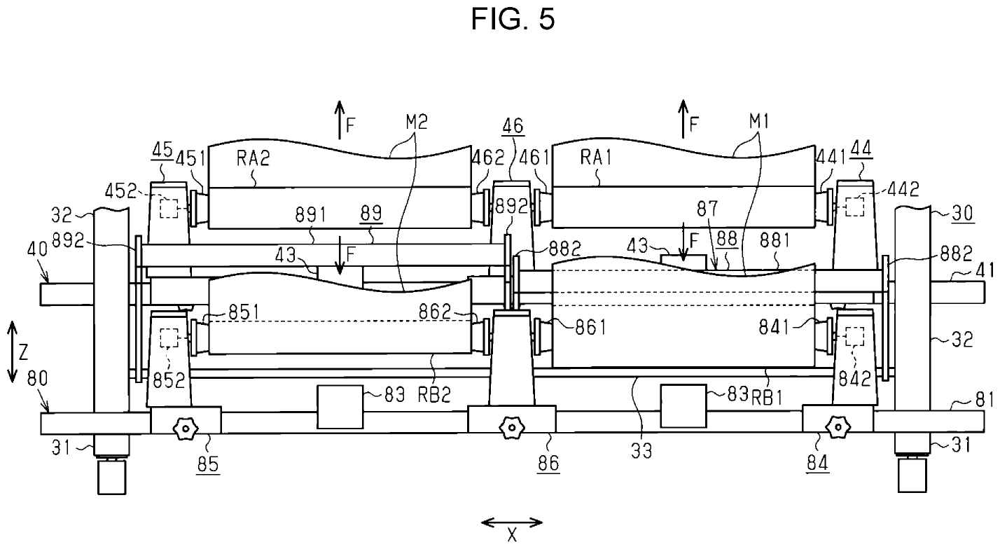

Next, an operation of the printing apparatus 10 of the embodiment will be described with reference to FIGS. 4 and 5.

First, with reference to FIG. 4, a case where the one roll body RA is held by the unwinding unit 40, the one roll body RB is held by the winding unit 80, and printing is performed on one medium M unwound from the one roll body RA will be described.

In this case, as illustrated in FIG. 4, in order to hold the roll body RA by the unwinding unit 40, the first holder 44 and the second holder 45 hold the roll body RA in a state in which the intermediate holder 46 is detached from the unwinding unit 40. In other words, the first rotary body 441 of the first holder 44 engages with the first end of the roll body RA, and the second rotary body 451 of the second holder 45 engage with the second end of the roll body RA.

In addition, as illustrated in FIG. 4, in the winding unit 80, the first holder 84 and the second holder 85 hold the roll body RB in a state in which the intermediate holder 86 is detached from the winding unit 80. In other words, the first rotary body 841 of the first holder 84 engages with the first end of the roll body RB, and the second rotary body 851 of the second holder 85 engages with the second end of the roll body RB. The medium M unwound from the roll body RA held by the unwinding unit 40, that is, the medium M transported by the transport unit 60, is wound into the roll body RB.

When preparation of printing is completed, the transport operation and the discharge operation are alternately performed, and thereby the printing is performed on the medium M. Here, in the transport operation, in the unwinding unit 40, the first rotary body 441 of the first holder 44 and the second rotary body 451 of the second holder 45 are rotatably driven, and thereby torque for rotating the roll body RA is applied to both ends of the roll body RA. Therefore, torsion is unlikely to be generated in the roll body RA around its axial direction, and thus an unwinding amount of the medium M from the unwinding unit 40 is uniform in the width direction X.

Similarly, in the winding unit 80, the first rotary body 841 of the first holder 84 and the second rotary body 851 of the second holder 85 are rotatably driven, and thereby torque for rotating the roll body RB is applied to both ends of the roll body RB. Therefore, torsion is unlikely to be generated in the roll body RB around its axial direction, and thus an unwinding amount of the medium M from the winding unit 80 is uniform in the width direction X.

Hence, when transporting the medium M unwound from the unwinding unit 40, an occurrence of transport disorder such as an occurrence of wrinkles or skewing of the medium M is reduced. As a result, when printing is performed on the transported medium M, it is possible to reduce a risk of a concern that printing will fail. In addition, when the winding of the medium M, on which the printing is finished, is performed, the occurrence of transport disorder such as a positional shift, in which a winding position of the medium M that is wound into the roll body RB is gradually shifted in the width direction X, is reduced.

In addition, in the case illustrated in FIG. 4, the first tension applying portion 88 and the second tension applying portion 89 are connected by a connecting member 871 in the width direction X. Therefore, the first tension applying portion 88 and the second tension applying portion 89 applies uniform tension to the medium M in the width direction X. Hence, compared to a case where the first tension applying portion 88 and the second tension applying portion 89 are not connected in the width direction, variations in the tension that is applied to the medium M in the width direction X are reduced, and the occurrence of the winding disorder is reduced.

Subsequently, with reference to FIG. 5, a case where the two roll bodies RA1 and RA2 are held by the unwinding unit 40, the two roll bodies RB1 and RB2 are held by the winding unit 80, and printing is performed on two media M1 and M2 unwound from the two roll bodies RA1 and RA2 will be described.

In this case, in a state in which the intermediate holder 46 is installed in the unwinding unit 40, in order to hold the two roll bodies RA1 and RA2 by the unwinding unit 40, the first holder 44 and the intermediate holder 46 engages with the first roll body RA1, and the second holder 45 and the intermediate holder 46 engage with the second roll body RA2. In other words, the first rotary body 441 of the first holder 44 engages with the first end of the first roll body RA1, and the first intermediate rotary body 461 of the intermediate holder 46 engages with the second end of the first roll body RA1. In addition, the second rotary body 451 of the second holder 45 engages with the second end of the second roll body RA2, and the second intermediate rotary body 462 of the intermediate holder 46 engages with the first end of the second roll body RA2.

In addition, in the winding unit 80, in a state in which the intermediate holder 86 is mounted in the winding unit 80, the first holder 84 and the intermediate holder 86 engage with the first roll body RB1, and the second holder 85 and the intermediate holder 86 engage with the second roll body RB2. In other words, the first rotary body 841 of the first holder 84 engages with the first end of the first roll body RB1, and the first intermediate rotary body 861 of the intermediate holder 86 engages with the second end of the first roll body RB1. In addition, the second rotary body 851 of the second holder 85 engages with the second end of the second roll body RB2, and the second intermediate rotary body 862 of the intermediate holder 86 engages with the first end of the second roll body RB2.

The medium M1 unwound from the first roll body RA1 held by the unwinding unit 40, that is, the medium M1 transported by the transport unit 60, is wound into the first roll body RB1 held by the winding unit 80. The medium M2 unwound from the second roll body RA2 held by the unwinding unit 40, that is, the medium M2 transported by the transport unit 60, is wound into the second roll body RB2 held by the winding unit 80.

When the preparation of printing is completed, the transport operation and the discharge operation are alternately performed, and thereby the printing is performed on the media M1 and M2. Here, in the transport operation, in the unwinding unit 40, the first rotary body 441 of the first holder 44 is rotatably driven, and thereby torque for rotating the first roll body RA1 is applied to the first end of the first roll body RA1.

In addition, the second rotary body 451 of the second holder 45 is rotatably driven, and thereby torque for rotating the second roll body RA2 is applied to the second end of the second roll body RA2. The unwinding unit 40 rotates the first roll body RA1, thereby unwinding the first medium M1, and the unwinding unit rotates the second roll body RA2, thereby unwinding the second medium M2.

Similarly, even in the winding unit 80, the first rotary body 841 of the first holder 84 is rotatably driven, and thereby torque for rotating the first roll body RB1 is applied to the first end of the first roll body RB1. In addition, the second rotary body 851 of the second holder 85 is rotatably driven, and thereby torque for rotating the second roll body RB2 is applied to the second end of the second roll body RB2. The winding unit 80 rotates the first roll body RB1, thereby winding the first medium M1, and the winding unit rotates the second roll body RB2, thereby winding the second medium M2.

Here, when a medium M having the maximum length in the width direction X of the media M on which printing can be performed by the printing apparatus 10 is referred to as the “medium M having the maximum width”, in the embodiment, the length of the first medium M1 and the second medium M2 in the width direction X is about half of the maximum width of the medium M. Hence, in a case where the first medium M1 and the second medium M2 are unwound from the first roll body RA1 and the second roll body RA2, the torque for rotating the roll bodies RA1 and RA2 is small, compared to a case where the medium M having the maximum width is unwound from the roll body into which the medium M having the maximum width is wound.

In addition, the lengths of the roll bodies RA1 and RA2 are short in the width direction X, and thus the torsion is unlikely to be generated in the roll bodies RA1 and RA2 around the axial direction. Similarly, even in a case where the first medium M1 and the second medium M2 are unwound from the first roll body RB1 and the second roll body RB2, the torsion is unlikely to be generated in the roll bodies RB1 and RB2 around the axial direction, compared to a case where the medium M having the maximum width is unwound from the roll body into which the medium M having the maximum width is wound.

Therefore, the occurrence of the transport disorder is reduced when the media M1 and M2 unwound from the first roll body RA1 and the second roll body RA2 are transported in the unwinding unit 40, and the occurrence of the winding disorder is reduced in a case where the media M1 and M2 is wound into the first roll body RB1 and the second roll body RB2 in the winding unit 80.

In addition, as described above, in the printing apparatus 10 of the embodiment, when the outer diameter of the roll body RA held by the unwinding unit 40 is small, the roll body RA is caused to rotate at a high rotation speed in order to maintain the unwinding amount of the medium M per unit time in response to an increase in the transport amount of the medium M. In addition, when the outer diameter of the roll body RB held by the winding unit 80 is small, the roll body RB is caused to rotate at a low rotation speed in order to maintain the winding amount of the medium M per unit time.

Here, in the printing apparatus 10 of the embodiment, the first roll body RA1 and the second roll body RA2 are caused to rotate at different rotation speeds from each other in the unwinding unit 40, and the first roll body RB1 and the second roll body RB2 can be caused to rotate at different rotation speeds from each other in the winding unit 80. Therefore, in the unwinding unit 40, in a case where the outer diameters of the first roll body RA1 and the second roll body RA2 are different from each other, it is possible to unwind the media M1 and M2 at unwinding rates (unwinding amount per unit time) depending on the transport rates of the medium M1 and M2. In addition, in the winding unit 80, in a case where the outer diameters of the first roll body RB1 and the second roll body RB2 are different from each other, it is possible to wind the media M1 and M2 at winding rates (winding amount per unit time) depending on the transport rates of the media M1 and M2.

As illustrated in FIG. 5, the unwinding unit 40, in a case where the outer diameter of the first roll body RA1 is equal to the outer diameter of the second roll body RA2, the rotation speed of the first roll body RA1 is equal to the rotation speed of the second roll body RA2. In addition, the winding unit 80, in a case where the outer diameter of the first roll body RB1 is larger than the outer diameter of the second roll body RB2, the rotation speed of the first roll body RB1 is lower than the rotation speed of the second roll body RB2.

In addition, in the winding unit 80, in a case where the outer diameters of the first roll body RB1 and the second roll body RB2 are different from each other, different tension is applied to the media M1 and M2 from each other such that the media M1 and M2 are appropriately wound. In this respect, according to the embodiment, since the first tension applying portion 88 and the second tension applying portion 89 are capable of individually oscillating, the tension suitable for the outer diameters of the roll bodies RB1 and RB2 is applied to the media M1 and M2. In other words, as illustrated in FIG. 5, oscillation angles of the first tension applying portion 88 and the second tension applying portion 89 change depending on the outer diameters of the first roll body RB1 and the second roll body RB2, and thereby the tension suitable for the outer diameters of the roll bodies RB1 and RB2 is applied to the medium M.

Further, in a case where the printing on the first medium M1 is finished earlier than the printing on the second medium M2, drive of the first motor 442 of the first holder 44 of the unwinding unit 40 and the first motor 842 of the first holder 84 of the winding unit 80 is stopped. Therefore, the first medium M1 is difficult to be transported, and thus wasteful consumption of the first medium M1 that is irrelevant to the printing is reduced.

According to the embodiment described above, it is possible to obtain the following effects.

(1) In a case where the printing is performed on one medium M, the first motor 442 and the second motor 452 of the unwinding unit 40 rotatably drive the first rotary body 441 and the second rotary body 451, and thereby it is possible to apply torque for rotating the roll body RA to both ends of the roll body RA. Hence, as the torque is applied from both ends, torsion is unlikely to be generated in the roll body RA around its axial direction, and thus the unwinding amount of the medium M from the unwinding unit 40 is likely to be uniform in the width direction X. Hence, when transporting the medium M unwound from an unwinding unit 40 that holds the roll body RA, it is possible to reduce the occurrence of the transport disorder of the medium M.

(2) The intermediate holder 46 is installed in the unwinding unit 40. In this manner, both ends of the first roll body RA1 engage with the first rotary body 441 and the first intermediate rotary body 461, and both ends of the second roll body RA2 engage with the second rotary body 451 and the second intermediate rotary body 462. Thus, the unwinding unit 40 is capable of holding the two roll bodies RA1 and RA2. The unwinding unit 40 can unwind the first medium M1 from the first roll body RA1 and unwind the second medium M2 from the second roll body RA2.

In addition, in a case where the unwinding unit 40 holds the two roll bodies RA1 and RA2, the torque is applied to only one end of each of the two roll bodies RA1 and RA2 in the width direction X. Incidentally, in a case where the two roll bodies RA1 and RA2 are held, the length of the roll body in the width direction X is shorter than the length of one roll body RA in a case where only the roll body RA is held. The tension is unlikely to be generated around the axial direction because the torque required for rotating the roll body is small or the like. Hence, while reducing the occurrence of transport disorder of the two media M1 and M2, it is possible to increase printing efficiency in that it is possible to perform the printing on the two media M1 and M2 at the same time.

(3) In a case where the printing is performed on the two media M1 and M2, and the printing on the first medium M1 and the second medium M2 is finished at different timings, the medium M, on which the printing is already finished, is stopped from being unwound and wound. In this manner, in a case where the printing is continuously performed on one medium M of the first medium M1 and the second medium M2, and the printing on the other medium M is finished, the other medium M is restricted from being continuously transported. Hence, the medium M, on which printing is finished earlier, is continuously transported, and thereby it is possible to avoid wasteful consumption of the corresponding medium M.

(4) In the winding unit 80, the first motor 842 is provided in the first holder 84 and the second motor 852 is provided in the second holder 85. Therefore, in a case where the printing is performed on one medium M, it is possible to apply the torque for rotating the roll body RB to both ends of the roll body RB in the winding unit 80, and thus the torsion is unlikely to be generated in the roll body RB around the axial direction. Hence, it is possible to reduce the occurrence of winding disorder of the medium M.

(5) The intermediate holder 86 is installed in the winding unit 80. In this manner, both ends of the first roll body RB1 engage with the first rotary body 841 and the first intermediate rotary body 861, and both ends of the second roll body RB2 engage with the second rotary body 851 and the second intermediate rotary body 862. Thus, the winding unit 80 is capable of holding the two roll bodies RB1 and RB2.

Hence, in a case where the printing is performed on the two media M1 and M2 unwound from the two roll bodies RA1 and RA2, it is possible to individually wind the two media M1 and M2 into the roll bodies RB1 and RB2. In addition, in a case where the transport speeds of the first medium M1 and the second medium M2 are equal to each other, it is possible to cope with a case where the rotation speeds of the first roll body RB1 and the second roll body RB2 need to be different from each other in the winding unit 80 such as a case where the outer diameters of the first roll body RB1 and the second roll body RB2 of the winding unit 80 are different from each other.

(6) The first tension applying portion 88 and the second tension applying portion 89 are provided to be aligned in the width direction X, and thereby it is possible to individually apply different tension to the first medium M1 and the second medium M2. Therefore, it is possible to change the tension, which is applied to the first medium M1 and the second medium M2, depending on a type of medium M, or to change the tension depending on the outer diameter of the roll bodies RB1 and RB2 in the winding unit 80.

(7) In a case where the printing apparatus 10 performs printing on the one medium M because the first tension applying portion 88 and the second tension applying portion 89 can be connected to each other, the medium M unwound from the one roll body RA is pressed by the first pressing portion 881 and the second pressing portion 891 which are connected to the each other in the width direction X, and thereby it is possible to obtain uniform tension that is applied to the one medium M in the width direction X. Therefore, compared to a case where the first pressing portion 881 and the second pressing portion 891 individually apply tension to the one medium M, the winding disorder is unlikely to occur.

The embodiment described above may be modified as follows.
Even in a case where the printing is finished on the other medium M of the first medium M1 and the second medium M2 earlier, the other medium M may be continuously unwound or wound.
The printing apparatus 10 may not include the winding unit 80 and the tension applying mechanism 87. In this case, preferably, the printing apparatus 10 includes a container (stacker) that contains the medium M on which the printing is finished.
The tension applying mechanism 87 may have only one tension applying portion in the width direction X or may have three or more tension applying portions in the width direction X. In a case where the three or more tension applying portions are provided, preferably, a tension applying portions to be connected is selected, as the width of the medium M.
The winding unit 80 may not include the intermediate holder 86. In this case, when the printing apparatus 10 performs printing on the two media M1 and M2, the winding unit 80 wounds the two media M1 and M2 into one roll body RB. Therefore, in this case, the first medium M1 and the second medium M2 have the same type as each other, and thus it is preferable that the outer diameter of the first medium M1 wound into one roll body RB be equal to the outer diameter of the second medium M2.
In the intermediate holders 46 and 86 of the unwinding unit 40 and the winding unit 80, the motor (drive unit) that drives the first intermediate rotary bodies 461 and 861 may be provided, or the motor (drive unit) that drives the second intermediate rotary bodies 462 and 862 may be provided.
The first tension applying portion 88 and the second tension applying portion 89 may not be able to be connected in the width direction X. In this case, even in a case where the printing is performed on the one medium M, the first tension applying portion 88 and the second tension applying portion 89 individually apply tension on the one medium M.
One tension applying portion may be provided to have a length corresponding to a total length of the first tension applying portion 88 and the second tension applying portion 89 in the width direction X.
In a case where the medium M is unwound from the one roll body RA in the unwinding unit 40, a torque ratio between the torque applied to the roll body RA by the first rotary body 441 of the unwinding unit 40 and the torque applied to the roll body RA by the second rotary body 451 may or may not be “1:1”. An example in which the torque ratio is not “1:1”, includes a case where assist torque is generated to one rotary body of the first rotary body 441 and the second rotary body 451, and torque for rotating the roll body RA is generated in the other rotary body. Here, the assist torque is torque that is smaller than the torque for rotating the roll body RA when the medium M is unwound. In other words, even when only the assist torque is applied to the roll body RA, the roll body RA does not rotate. In addition, similarly to a case where the medium M is wound into one roll body RB in the winding unit 80, the torque ratio in the first rotary body 841 and the second rotary body 851 may appropriately change.
In a case where, in the middle of performing the printing on one medium M unwound from one roll body, the printing is finished on the other medium M unwound from the other roll body, a locking mechanism that locks the rotation of the one roll body in the unwinding unit 40 may be provided such that the other medium M is not unwound even when the transport unit 60 applies a transport force to the other medium M.
In a case where the printing is performed on the two media M1 and M2 at the same time, and the printing on the other medium M is stopped due to the transport disorder or by the instruction of the user (a case where the printing is not performed), the other medium M is restricted from being transported, and the one medium M may be allowed to be transported.
The printing apparatus 10 may be changed to a so-called full-line type printing apparatus that includes the discharge portion 71 fixed to have an elongated shape corresponding to the entire width of the medium M without the carriage 72. In the discharge portion 71 in this case, a plurality of unit heads provided with nozzles are aligned, and thereby a printing region may be all along the entire width of the medium M. Otherwise, multiple nozzles are arranged in one single elongated head all along the entire width of the medium M, and thereby the printing region may be all over the entire width of the medium M.
A liquid ejected by the discharge portion 71 is not limited to the ink and may be a liquid body in which particles of functional materials are dispersed or mixed in a liquid. For example, a configuration, in which recording is performed by ejecting a liquid body containing, in a dispersing or dissolving manner, a material such as an electrode material or color material (pixel material) which is used in manufacturing or the like of a liquid crystal display, an electroluminescence (EL) display, and a field emission display, may be employed.
The printing apparatus 10 is not limited to a printer that ejects a fluid such as the ink and performs recording, and the printing apparatus may be a non-impact printer such as a laser printer, an LED printer, or a thermal transfer printer (including sublimation type printer) or may be an impact printer such as a dot impact printer.
The medium M is not limited to paper, and the medium S may be a plastic film, a thin plate material, or the like or may be cloth used in a textile printing apparatus or the like.

### REFERENCE SIGNS LIST

10 PRINTING APPARATUS
20 HOUSING
30 HOUSING SUPPORT
31 FIRST LEG
32 SECOND LEG
33 CONNECTING SHAFT
34 EXTENSION PORTION
40 UNWINDING UNIT
41 GUIDE SHAFT
42 HOLDING UNIT
43 MOUNTING PORTION
44 FIRST HOLDER
441 FIRST ROTARY BODY
442 FIRST MOTOR
443 FIXING SCREW
45 SECOND HOLDER
451 SECOND ROTARY BODY
452 SECOND MOTOR
453 FIXING SCREW
46 INTERMEDIATE HOLDER
461 FIRST INTERMEDIATE ROTARY BODY
462 SECOND INTERMEDIATE ROTARY BODY
463 FIXING SCREW
50 MEDIUM SUPPORT
51 FIRST MEDIUM SUPPORT
52 SECOND MEDIUM SUPPORT
53 THIRD MEDIUM SUPPORT
60 TRANSPORT UNIT
61 DRIVE ROLLER
62 DRIVEN ROLLER
70 PRINTING UNIT
71 DISCHARGE PORTION
72 CARRIAGE
73 GUIDE SHAFT
80 WINDING UNIT
81 GUIDE SHAFT
82 HOLDER
83 MOUNTING PORTION
84 FIRST HOLDER
841 FIRST ROTARY BODY
842 FIRST MOTOR
843 FIXING SCREW
85 SECOND HOLDER
851 SECOND ROTARY BODY
852 SECOND MOTOR
853 FIXING SCREW
86 INTERMEDIATE HOLDER
861 FIRST INTERMEDIATE ROTARY BODY
862 SECOND INTERMEDIATE ROTARY BODY
863 FIXING SCREW
87 TENSION APPLYING MECHANISM
871 CONNECTING MEMBER
88 FIRST TENSION APPLYING PORTION
881 FIRST PRESSING PORTION
882 FIRST ARM MEMBER
89 SECOND TENSION APPLYING PORTION
891 SECOND PRESSING PORTION
892 SECOND ARM MEMBER
90 OPERATING UNIT
100 CONTROLLER
F TRANSPORT DIRECTION
M MEDIUM
X WIDTH DIRECTION
Y FRONT/REAR DIRECTION
Z VERTICAL DIRECTION
M1 FIRST MEDIUM
M2 SECOND MEDIUM
RA ROLL BODY
RB ROLL BODY
RA1 FIRST ROLL BODY
RA2 SECOND ROLL BODY
RB1 FIRST ROLL BODY
RB2 SECOND ROLL BODY

1. A printing apparatus that performs printing on a medium unwound from a roll body having the medium wound into a cylindrical shape, the printing apparatus comprising:
an unwinding unit that rotatably holds the roll body and unwinds the medium by rotating the roll body;
a transport unit that transports the medium unwound from the unwinding unit; and
a printing unit that performs printing on the medium transported by the transport unit,
wherein the unwinding unit includes a first rotary body that is integrally rotatable with the roll body by engaging with a first end of the roll body, a first drive unit that rotatably drives the first rotary body, a second rotary body that is integrally rotatable with the roll body by engaging with a second end of the roll body, and a second drive unit that rotatably drives the second rotary body.

2. The printing apparatus according to claim 1, further comprising:
a winding unit that rotatably holds the roll body and rotates the roll body so as to wind the medium on which printing has been performed by the printing portion,
wherein the winding unit includes a first rotary body that is integrally rotatable with the roll body by engaging with the first end of the roll body, a first drive unit that rotatably drives the first rotary body, a second rotary body that is integrally rotatable with the roll body by engaging with the second end of the roll body, and a second drive unit that rotatably drives the second rotary body.

3. The printing apparatus according to claim 1,
wherein, when a direction in which the first rotary body and the second rotary body of the unwinding unit face each other is a width direction,
the unwinding unit includes an intermediate holder provided with a first intermediate rotary body that is integrally rotatable with the roll body by engaging with the second end of the roll body of which the first end engages with the first rotary body of the unwinding unit and a second intermediate rotary body that is integrally rotatable with the roll body by engaging with the first end of the roll body of which the second end engages with the second rotary body of the unwinding unit, the intermediate holder being installed between the first rotary body and the second rotary body of the unwinding unit in the width direction.

4. The printing apparatus according to claim 2,
wherein the winding unit includes an intermediate holder provided with a first intermediate rotary body that is integrally rotatable with the roll body by engaging with the second end of the roll body of which the first end engages with the first rotary body of the winding unit and a second intermediate rotary body that is integrally rotatable with the roll body by engaging with the first end of the roll body of which the second end engages with the second rotary body of the winding unit, the intermediate holder being installed between the first rotary body and the second rotary body of the winding unit.

5. The printing apparatus according to claim 3,
wherein, when the medium unwound from the roll body of which both ends engage with the first rotary body and the first intermediate rotary body of the unwinding unit is a first medium, and the medium unwound from the roll body of which both ends engage with the second rotary body and the second intermediate rotary body of the unwinding unit is a second medium,
of the first medium and the second medium, one medium is allowed to be transported, but the other medium is restricted from being transported in a case where printing is not performed on the other medium in the middle of performing printing on the one medium.

6. The printing apparatus according to claim 3, further comprising:
a first tension applying portion that is capable of applying tension to the first medium by pressing the first medium in a direction intersecting with both directions of a transport direction of the first medium and the width direction and a second tension applying portion that is capable of applying tension to the second medium by pressing the second medium in a direction intersecting with both directions of a transport direction of the second medium and the width direction, when the medium unwound from the roll body of which both ends engage with the first rotary body and the first intermediate rotary body of the unwinding unit is a first medium, and the medium unwound from the roll body of which both ends engage with the second rotary body and the second intermediate rotary body of the unwinding unit is a second medium.

7. The printing apparatus according to claim 6,
wherein the first tension applying portion and the second tension applying portion can be connected to each other in the width direction.
